(19) United States
(12) Patent Application Publication
(10) Pub. No.: US 2003/0061662 A1
(43) Pub. Date: Apr. 3, 2003

(54) Adjustable patient positioning device

(76) Inventors: Georg Strobel, Obertraubling (DE); Konrad Christ, Markranstadt (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/260,390

(22) Filed: Oct. 1, 2002

(30) Foreign Application Priority Data
Oct. 1, 2001 (AT) A1546/2001

(51) Int. Cl. A61G 13/08; A61G 7/015; A61G 7/018

(52) U.S. Cl. 5/618; 5/614

(57) ABSTRACT

A spatially-adjustable patient positioning surface (1) of an operating table, for example, is connected to at least two hydraulic cylinders (2, 3, 3′, 24) which are separately controllable by two control elements. The control elements are combined in at least one rotary distributor (26, 27) that is adjustable by means of one common adjustment arrangement (25).

### BACKGROUND OF THE INVENTION

1. Field of the Invention

The invention relates to an adjustable patient positioning device, particularly an operating table, having at least one hydraulically-actuated, spatially adjustable patient positioning surface that is connected for its adjustment to two separately controllable pressure-medium drives, particularly hydraulic cylinders.

2. The Prior Art

Devices of the aforementioned type are disclosed, for example, in DE 33 28 908 C2, DE 44 23 402 C2 or DE 197 52 928 C1, and they allow the physician or surgeon to move the patient into a position that is favorable for the respective treatment or to a reachable position in general. In simpler devices, such as dentist chairs, there is often a dual adjustment possibility sufficient—a central height adjustment, on one hand, and lowering of the backrest while simultaneously lifting the leg-rest, on the other hand—to bring the patient positioning surface at least to an essentially horizontal position. In general, additional adjustment possibilities are needed for operating tables, gynecological examination/treatment chairs and the like to make also possible lateral pivoting of the patient positioning surface or an independent adjustment of the leg-rest or backrest surface or the like. For each separate adjustment possibility there is a separate control element necessary for the corresponding pressure medium drive, which not only causes higher costs because of the corresponding amount of seat valves or gate valves in the electromagnetic driven or electric driven adjustment, commonly used in this area, but it also increases the risk of malfunctioning or faulty operation.

It is the object of the present invention to avoid the mentioned disadvantages of the prior art patient positioning devices to design, in particular, a device of this type in such a manner that controlling of the pressure medium drives is made mechanically simpler and safer.

### SUMMARY OF THE INVENTION

The object of the invention is achieved with a patient positioning device of the aforementioned type whereby the control elements of at least one part of the pressure medium drives is combined with a least one rotary distributor that is adjustable by means of a common adjustment arrangement, particularly a rotary slide valve having a slide valve arranged in a housing that controllably connects the controlling openings that are assigned to the intake and discharge lines of the pressure medium drives leading to a pressure medium source and to a pressure medium discharge element. It is ensured thereby that at least the control units combined respectively in the rotary distributor require only one common adjustment arrangement, which substantially simplifies the mechanical design, reduces the space needed for mounting, and makes installation and maintenance simpler and more cost-effective. In addition, the risk of faulty operation is reduced since only single adjustment functions, or groups of adjustment functions intended constructively therefor, may be performed in sequence. Apart from the individual rotary distributors used for lifting, pivoting about the longitudinal axis, and pivoting about the transverse axis, there may be provided additional rotary distributors, e.g., for the separate adjustment of the leg-rests and one for the separate adjustment of the backrest or the like, whereby the concept of combination of individual adjustment functions may be given priority, and whereby there are no limitations in the structural possibilities of the invention in this regard.

In an especially preferred embodiment of the invention, one (or each) rotary distributor is adjustable by means of an electric motor whereby the respective position is detected by a rotation sensor (especially one having micro-switches), electric shaft encoders, proximity switches or the like, and whereby the detected values are processed in a connected control unit. Only one electric motor of this type, together with the corresponding sensor, is required for each rotary distributor so that higher-value components can be preferably used without detrimental effects on expenditures or on the complexity of the device, for example.

According to another preferred embodiment of the invention, a manually-actuated emergency adjustment device is included on the rotary distributor in addition to an electric motor, which makes possible a very simple emergency operation since this adjustment arrangement has to be rotated only throughout one axis and which may thereby be realized in a very simple manner by means of a hand wheel or the like without having the risk of faulty operations.

The invention will now be explained in more detail with the aid of embodiment examples illustrated in part schematically in the accompanying drawings.

### BRIEF DESCRIPTION OF THE DRAWINGS

FIG. 1 shows a perspective top view onto a patient positioning device according to the invention;

FIG. 2 shows a perspective view of the central lifting column provided with the adjustment components of an additional embodiment example of the invention while the actual patient positioning table is removed;

FIGS. 3 and 4 show circuit diagrams of hydraulic actuation arrangements designed in accordance with the state-of-the-art of patient positioning devices;

FIG. 5 shows as an example a hydraulic circuit diagram for a patient positioning device according to FIGS. 1 and 2 of the present invention;

FIG. 6 shows a longitudinal view through a rotary distributor of a patient positioning device of the invention (according to FIG. 5 or FIGS. 1 and 2);

FIGS. 7 and 8 show views along lines VII-VII and VIII-VIII in FIG. 6; and

FIG. 9 shows a view along arrow IX in FIG. 6.

### DETAILED DESCRIPTION OF THE PREFERRED EMBODIMENTS

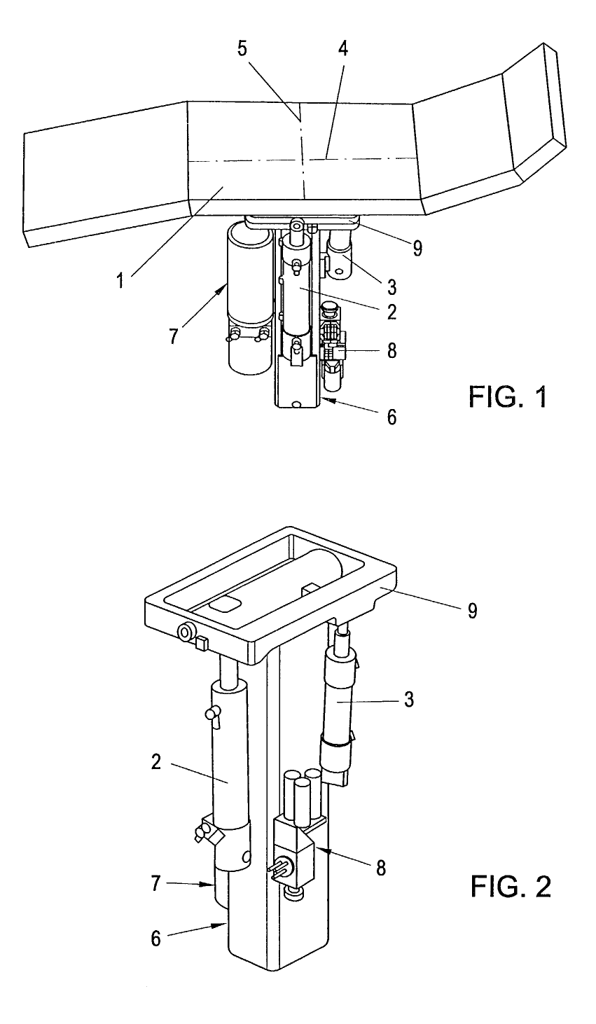

The adjustable patient positioning device in FIG. 1 may be used as operating table and it is provided with a hydraulically operated, spatially-adjustable patient positioning surface 1, which may be pivoted about the longitudinal axis 4 or the transverse axis 5 by means of pressure medium drives 2, 3. In addition, there is arranged a third pressure medium drive at the inside of the essentially square lifting column 6 (not visible) by which the patient positioning surface 1 is additionally adjustable in height.

A power pack 7 is arranged on the lifting column 6 for delivery of pressure medium to all pressure-medium drives designed as hydraulic cylinders whereby the power pack 7 combines a tank, pump and motor (not separately visible) and whereby the power pack 7 is connected to a pressure medium drive via a pressure medium line (not shown) and an in-line control unit 8.

FIG. 2 shows the lifting column 6 together with a support frame 9, which is swivable on gimbals (universal joints)—the actual patient positioning surface (1 in FIG. 1) is removed in the drawing. Identical parts, or at least parts corresponding identical in their functioning, are given the same reference numbers as in FIG. 1. Not shown in the two drawings is the floor mounting of the lifting column 6 or the traditionally used cover therefor. As it can be seen in FIGS. 1 and 2, the lifting column 6 is designed as a free-standing unit, which includes the mounting components and which needs for its placement only an electric connection to the pump of the power pack 7 or to the control unit 8 and to a possible control line for remote-control (not illustrated) or the like.

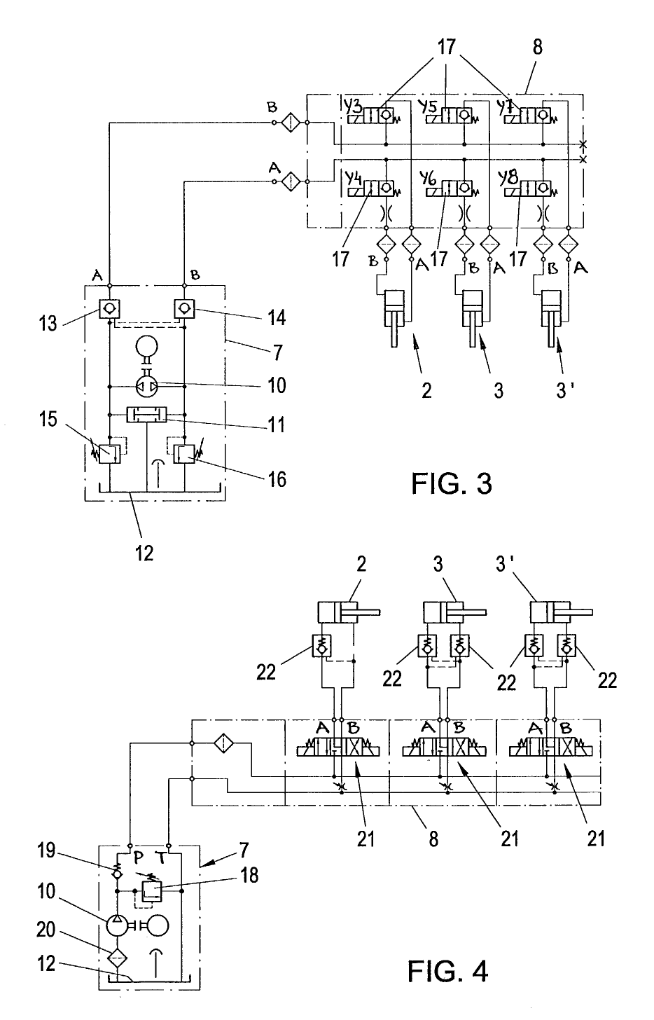

In FIG. 3 there is illustrated by example a power pack 7 including a control unit 8 and three pressure-medium drives as they are used according to the prior art together with a seat valve interconnection of the control unit 8 for the required control or adjustment of a patient positioning surface (e.g. 1 in FIG. 1). Inside the power pack 7, there is a selectively reversible pump 10, which is connected to the tank 12 via a shuttle valve 11, on one side and which is connected on the other side to two connections A and B. In front of the connection A and B, there are connected in-line additionally two reciprocal pilot-controlled check valves 13, 14 and on the tank-side there are two adjustable pressure control valves 15, 16.

Two seat valves 17 are provided in the control unit 8 for each of the pressure medium drives 2, 3, 3′, which are biased by a spring on one side and which are adjustable on the other side by means of a switching magnet (Y3 through Y8). The corresponding connection elements to the pressure-medium drives 2, 3, 3′ and to the entire control unit 8 are again identified with the letters A and B.

Assuming corresponding pressure influences on the connections A and B, the pressure-medium drives 2, 3, 3′ may be pushing or pulling (the latter drive 3′ is the one for height adjustment and is not visible in FIGS. 1 and 2), which causes corresponding adjustment movements of the patient positioning surface (1 in FIG. 1) or of the support frame 9 (FIGS. 1 and 2). Separate adjustability requires here two seat valves for each of the pressure-medium drives, respectively, and which requires in turn six switching magnets and corresponding controls with electric power supply and hydraulic medium supply. All in all, this arrangement is therefore relatively costly and susceptible to faulty operation.

In FIG. 4 there is schematically illustrated an arrangement essentially corresponding to the one in FIG. 3 according to the state-of-the-art. Identical parts, or correspondingly functioning parts, are again identified with the reference numbers used up to now. The power pack 7 is provided with a pressure connection identified with P and a connection to the tank 12 is identified with T, whereby a pressure control valve 18 is connected in-line parallel between the two connections, and a spring-biased check valve 19 is connected in series. Pump 10, turning only in one direction, sucks fluid from the tank 12 through a filter 20 and supplies pressure to the pre-selected side of the hydraulic cylinders (2, 3, 3′) depending on the switching position of the three gate valves 21. These hydraulic cylinders are provided with one or two pilot-controlled check valves 22 that open to the opposite side and which make discharge possible from the cylinder-side only by the pressure acting upon the other side whereby said hydraulic cylinders ensure hydraulic holding in the respective position. Even though there occurs a reduction of components in this area, compared to FIG. 3 where only three gate valves 21 are required (compared to six individual seat valves 17), there are still six switching magnets necessary (two switching magnets are necessary for the adjustment of each gate valve 21), so that relatively high costs are still incurred relative to the electric actuation of the control elements, and the risk of faulty operation remains also high, just like before.

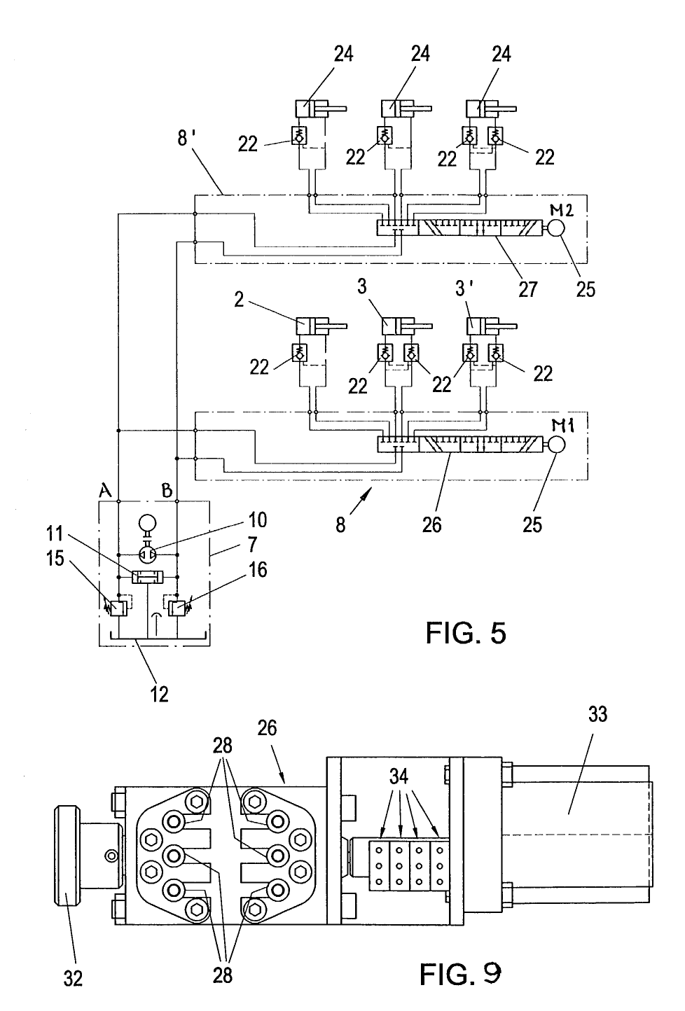

FIG. 5 illustrates now a schematic circuit diagram of the patient positioning device according to the invention wherein alone the control unit 8, illustrated in the lower area and directly bordering the power pack 7, fulfills the same functions as the ones discussed for FIGS. 3 and 4. The additional control unit 8′, which is illustrated further in the upper area and which is connected parallel, together with the additional pressure-medium drives 24, to the control unit 8 with its pressure medium drives 2, 3, 3′ and the connections A and B of the power pack 7, makes possible an additional independent actuation and adjustment of the leg-rest and the backrest or the like of the patient positioning surface. The power pack 7 in FIG. 5 is designed essentially the same as the one in FIG. 3—missing are here only the pilot-controlled check valves (13, 14 in FIG. 3) in front of the connections A and B, whose functions are taken over by the separate pilot-controlled check valves 22 assigned to the pressure-medium drives 2, 3, 3′ and 24 (similarly as described for FIG. 4).

As a substantial deviation from prior art, there are control elements of the pressure-medium drives 2, 3, 3′ on one side, and 24 on the other side, combined in an adjustable rotary distributor 26, 27 by means of a common adjustment arrangement 25, which connects the controlling openings to the power pack 7 whereby said opening are assigned to the intake lines and discharge lines of the pressure medium drives by the connections A and B. The mutual adjustment arrangement is designed as an electric motor (M1 or M2) in both cases whereby the respective switching position of the rotary distributor is detected by a rotary sensor (not illustrated) via four separate micro-switches 34, and whereby said switching position is processed in a control device (also not illustrated). For the realization of identical adjustment functions, as discussed for FIG. 3 and FIG. 4, there is only one single control element required which needs only one electric motor for the adjustment so that, in this regard, costs are considerably reduced and the risk for faulty operations is reduced as well based on the preset switching sequence.

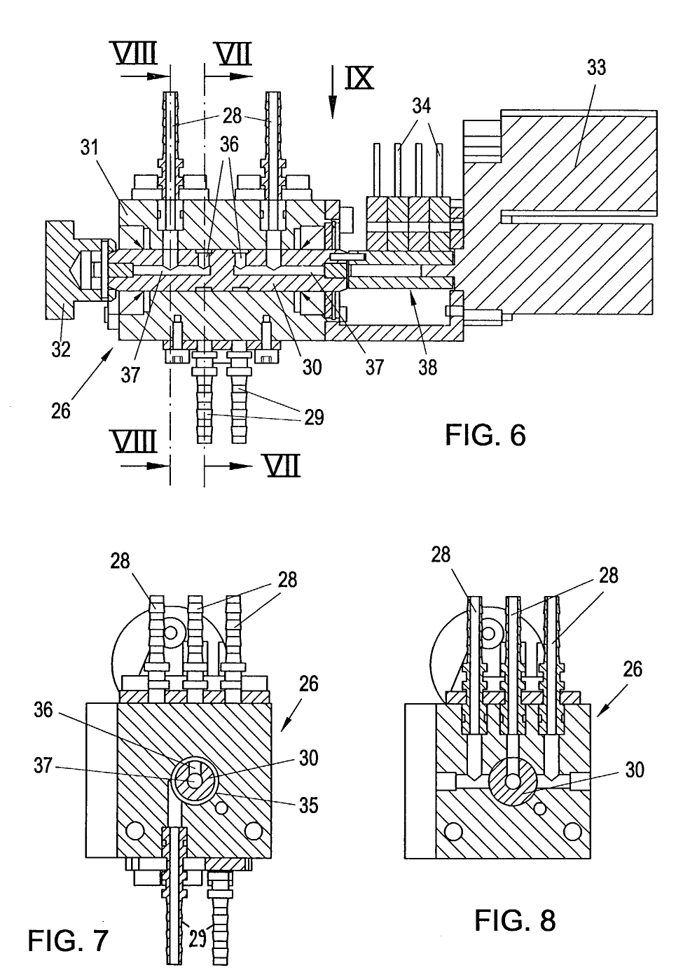

According to FIGS. 6 through 9, the rotary distributor 26 consists of a common housing 31 for all connection elements 28 (of the three not further illustrated pressure medium drives) as well as 29 (of the power pack) in which a rotary slide valve 30 is centrally arranged and which controls the controlling openings assigned to the intake lines and the discharge lines. On the left side of the housing 31 in FIG. 6 and FIG. 9, there is attached to the rotary slide valve 30 a manually-operated emergency adjustment device 32 in the form of a turning knob, whereas the rotary slide valve 30 is actuated under normal operation by means of an electric motor placed on the opposite side of the housing 31.

The connection elements 28 connect the rotary distributor 26 to the pressure-medium drives (2, 3, 3′ and 24 in FIG. 5). There is always one group of three connection elements assigned to the respective pressure connection and the second group of three connection elements is assigned to the respective fluid return connection. The function of the two groups is inverted by reversing the turning direction of the pump 10 in the power pack 7 (FIG. 5). The two connection elements 29 are dependent on the respective turning direction of the pump by being either a pressure connection or a connection to the tank. A third connection element on the side of the connection element 29 returns leaking oil from the rotary distributor 26. The connection elements 29 extend into the annular channels 35 (FIG. 7) on the rotary slide valve 30 whereby the annular channels 29 are connected to inner axial bores 37 via two radial bores 36 and take over the distribution function and closing function. In this way, no motor or only one electric motor, biased by a pressure-medium drive, is connected to the rotary slide valve 30 via a sleeve-type clutch 38 at different switching positions, whereby the clutch 38 is provided with indentations on its outer side which actuate the micro-switch 34 and which detect thereby the respective position of the rotary slide valve 30. Besides, the position of the rotary slide valve can also be detected by optical sensors, potentiometer, or the like (not illustrated).

We claim:

1. An adjustable patient positioning device, particularly an operating table, having at least one hydraulically-actuated, spatially-adjustable patient positioning surface (1) that is connected for its adjustment to two separately controllable pressure medium drives (2, 3, 3′, 24), wherein the control elements of at least one part of said pressure medium drives (22, 3, 3′, 24) is combined with a least one rotary distributor (26, 27) that is adjustable by means of a common adjustment arrangement (25), particularly a rotary slide valve having a slide valve arranged in a housing that controllably connects the controlling openings that are assigned to the intake and discharge lines of said pressure-medium drives (2, 3, 3′, 24) leading to a pressure medium source (10) and to a pressure-medium discharge element (12).

2. An adjustable patient positioning device according to claim 1, wherein said rotary distributor (26, 27) is adjustable by means of an electric motor (M1, M2) whereby the respective position is detected by a rotation sensor, electric shaft encoders, proximity switches or the like, and whereby the detected values are processed in a connected control unit.

3. An adjustable patient positioning device according to claim 2, wherein a manually-actuated emergency adjustment arrangement (32) is provided on said rotary distributor (26, 27) in addition to said electric motor (M1, M2).

4. An adjustable patient positioning device according to claim 1, wherein said pressure medium drives are hydraulic cylinders.
